(19) United States
(12) Patent Application Publication
(10) Pub. No.: US 2019/0108631 A1
(43) Pub. Date: Apr. 11, 2019

(54) SYSTEM AND METHOD FOR FIELD PATTERN ANALYSIS

(71) Applicant: AgriSight, Inc., Ann Arbor, MI (US)

(72) Inventors: Devin Riley, Ann Arbor, MI (US); Michael Asher, Ann Arbor, MI (US); Tracy Blackmer, Ann Arbor, MI (US)

(21) Appl. No.: 16/146,011

(22) Filed: Sep. 28, 2018

Related U.S. Application Data
(60) Provisional application No. 62/568,979, filed on Oct. 6, 2017.

(51) Int. Cl. G06T 7/00

(52) U.S. Cl. CPC G06T 7/0004; G06T 2207/30188

(57) ABSTRACT

A method for characterizing field patterns, including: receiving remotely sensed data of a geographic region; determining a feature set for the geographic region based on the remotely sensed data; identifying field patterns for the geographic region based on the feature set; and determining pattern characteristics for the identified field patterns.

### CROSS-REFERENCE TO RELATED APPLICATIONS

This application claims the benefit of U.S. Provisional Application No. 62/568,979 filed 6 Oct. 2017, each of which is incorporated in its entirety by this reference.

### TECHNICAL FIELD

This invention relates generally to the agricultural field, and more specifically to a new and useful system and method for field pattern analysis in the agricultural field.

### BRIEF DESCRIPTION OF THE FIGURES

FIG. 1 is a schematic representation of an embodiment of a method for field pattern characterization.

FIG. 2 is a schematic representation of an embodiment of a system for field pattern characterization.

FIG. 3 is a schematic representation of an embodiment of a method for field pattern characterization.

FIG. 4 is a graphical representation of an embodiment of a method for field pattern characterization.

FIG. 5 is a graphical representation of an example of image processing.

FIG. 6 is a graphical representation of an example of classification.

FIG. 7 is a graphical representation of an example of field pattern characterization.

FIG. 8 is a graphical representation of an example of field pattern characterization.

FIGS. 9A-9N are graphical representations of specific examples of field pattern-related situations.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

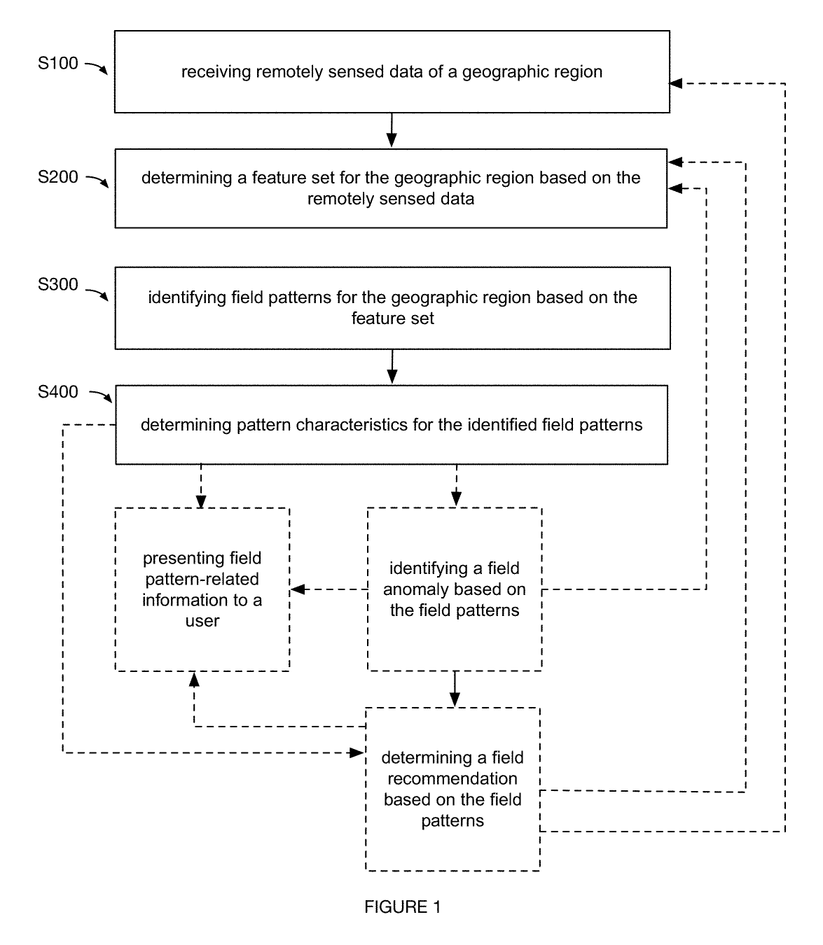

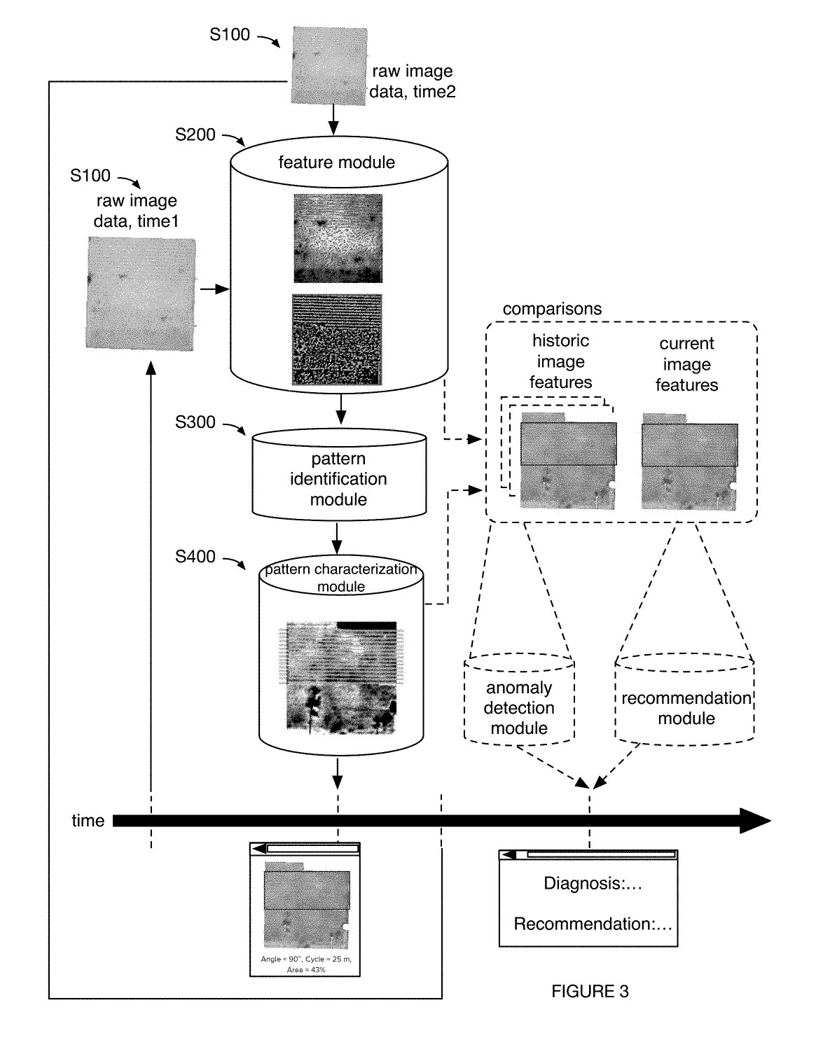

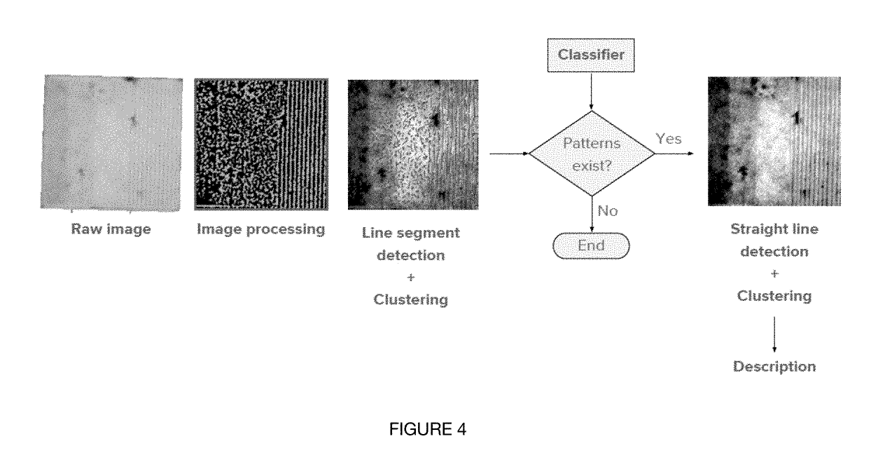

As shown in FIGS. 1, 3 and 4, embodiments of a method for characterizing field patterns can include: receiving remotely sensed data of a geographic region S100; determining a feature set for the geographic region based on the remotely sensed data S200; identifying field patterns for the geographic region based on the feature set S300; and determining pattern characteristics for the identified field patterns S400. Additionally or alternatively, the method 100 can include: identifying a field anomaly based on the field patterns; determining a field recommendation based on the field patterns; and/or any other suitable processes.

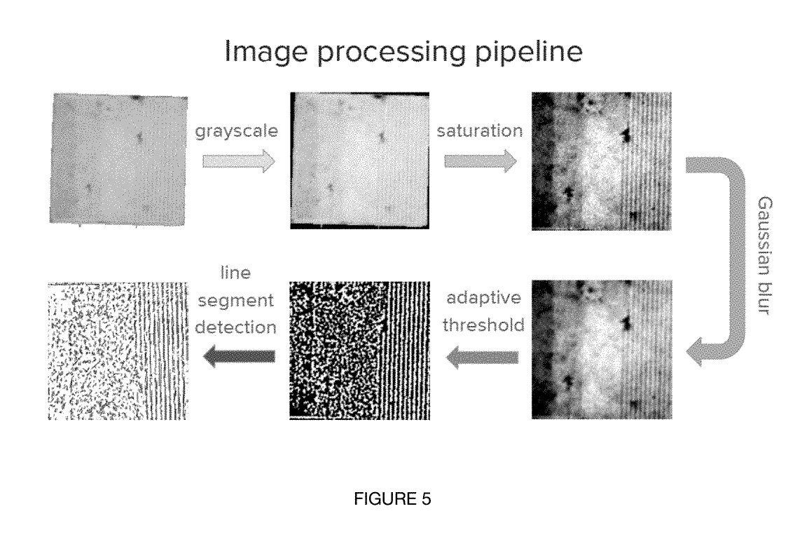

In a specific example, the method can include: collecting remotely sensed images (e.g., satellite images) of a geographic region (e.g., a physical crop field); performing pre-processing on the remotely sensed images (e.g., as shown in FIG. 5, performing operations associated with greyscale; saturation; blurring such as through Gaussian blurring; thresholding such as adaptive thresholding; etc.); detecting and clustering line segments (e.g., based on line segment length) for the pre-processed remotely sensed images; extracting features for the clustered line segments (e.g., average length, variance in angle, etc.); classifying (e.g., with a decision-tree classifier) the processed remotely sensed images as associated with field patterns (e.g., manmade field patterns) based on the features; and determining pattern characteristics for the identified field patterns (e.g., orientation; cycle, such as width between field patterns; amount of area covered by the field patterns; etc.) of the geographic region.

Embodiments of the method and/or system can function to identify and characterize field patterns (e.g., distinguishing between manmade field patterns and natural patterns; determining characteristics of such patterns; etc.), which can be used in a variety of applications. In a first application, field pattern characteristics (and/or other suitable data described herein) for a geographic region can be presented (e.g., at a web interface, etc.) to a user associated with the geographic region, in order to aid the user in performing farm management activities (e.g., modifying tillage operations, spraying operations, seeding operations, equipment operations, other suitable operations, etc.). In a second application, field patterns can be used in determining field anomalies (e.g., causes of yield deficiencies, etc.), which can be classified as associated with farm management (e.g., manmade errors, equipment errors, etc.), with natural parameters (e.g., weather parameters, soil variation parameters, etc.), and/or with other suitable criteria (e.g., for identifying causes of field outcomes such as yield amount, etc.). In a third application, field patterns can be used in generating and/or prescribing recommendations for: precision crop applications (e.g., variable application of pre-emergent herbicide, soil insecticide, residual type herbicides, fertilizers, etc.), precision crop treatment (e.g., by a farming machine), precision crop planting, and/or for any other suitable farm management activity. In a fourth application, the field patterns can be processed with prediction and/or prescription models (e.g., yield prediction models, soil characterization models, fertilizer prescription models, etc.), where the field patterns can be used as inputs for the models, used in generating, executing, refining, and/or otherwise processing the models, and/or used with the models in any suitable manner. In a specific example, field pattern characteristics can be used as features in a yield prediction model for improving accuracy of estimated crop yields for geographic regions. However, identified field patterns and/or associated characteristics can be used for any suitable application.

One or more instances and/or portions of the method and/or processes described herein can be performed asynchronously (e.g., sequentially), concurrently (e.g., in parallel; concurrently on different threads for parallel computing to improve system processing ability for processing remotely sensed data, extracting features, characterizing field patterns, etc.), in temporal relation to a trigger event (e.g., receiving an updated set of remotely sensed data for a geographic region; detecting a crop yield anomaly; etc.), and/or in any other suitable order at any suitable time and frequency (e.g., for the same or different geographic regions, etc.) by and/or using one or more instances of the system, elements, and/or entities described herein. However, the method and/or system can be configured in any suitable manner.

### 2. Benefits

In specific examples, the method and system can confer several benefits over conventional approaches. First, the technology can provide technical solutions necessarily rooted in computer technology (e.g., computationally processing digital images to extract features for identifying and characterizing field patterns based on the digital images; computationally refining digital modules with specialized datasets including remotely sensed imagery in an iterative process; etc.) to overcome issues specifically arising with the computer technology (e.g., improving accuracy for computationally identifying and characterizing field patterns; overcoming issues associated with distinguishing manmade field patterns from natural patterns; improving associated processing speeds for analyzing a plurality of geographic regions across a plurality of locations and users; etc.).

Second, the technology can confer an improvement to the functioning of farm management systems (e.g., fertilizer application equipment, seeding machinery, sprayer equipment, planters, tractors, harvesting equipment, etc.). For example, field pattern characteristics can be presented to a user for facilitating identification of correlations between farm management activities and deficiencies in farm management metrics (e.g., yield, nutrient status, etc.), where such actionable insights can lead to modifying usage of farm management systems (e.g., automatically, manually, etc.) to overcome the deficiencies in the farm management metrics.

Third, the technology can effect a transformation of an object to a different state or thing. Farm management systems can be activated and controlled according to control instructions determined, for example, based on identified and characterized field patterns (e.g., modifying tillage operations based on characterizations of field patterns associated with historic tillage operations and yield values; etc.). Digital imagery of a physical field can be processed (e.g., through suitable computer vision techniques, etc.) and transformed for identifying and characterizing field patterns of the physical field. Crop fields can be transformed (e.g., for improving associated yield; etc.) in response to modifications to farm management system operation.

Fourth, the technology can leverage specialized, non-generic systems, such as fertilizer application equipment, seeding machinery, sprayer equipment, planters, tractors, harvesting equipment, and/or other suitable farm management systems, in performing non-generic functions described herein, and/or in performing any suitable functions.

Fifth, the technology can leverage high-resolution data (e.g., high-resolution remotely sensed imagery; etc.) to more accurately and comprehensively identify and/or characterize field patterns, such as in an additional or alternative manner to using farm management machinery data (e.g., combine data and/or other machinery data, which can be distorted by machinery processing and/or be of lower resolution).

The technology can, however, provide any other suitable benefit(s) in the context of using non-generalized systems for identifying and characterizing field patterns; performing actions (e.g., farm management activities) based on the field patterns; and/or for other suitable purposes.

### 3. System

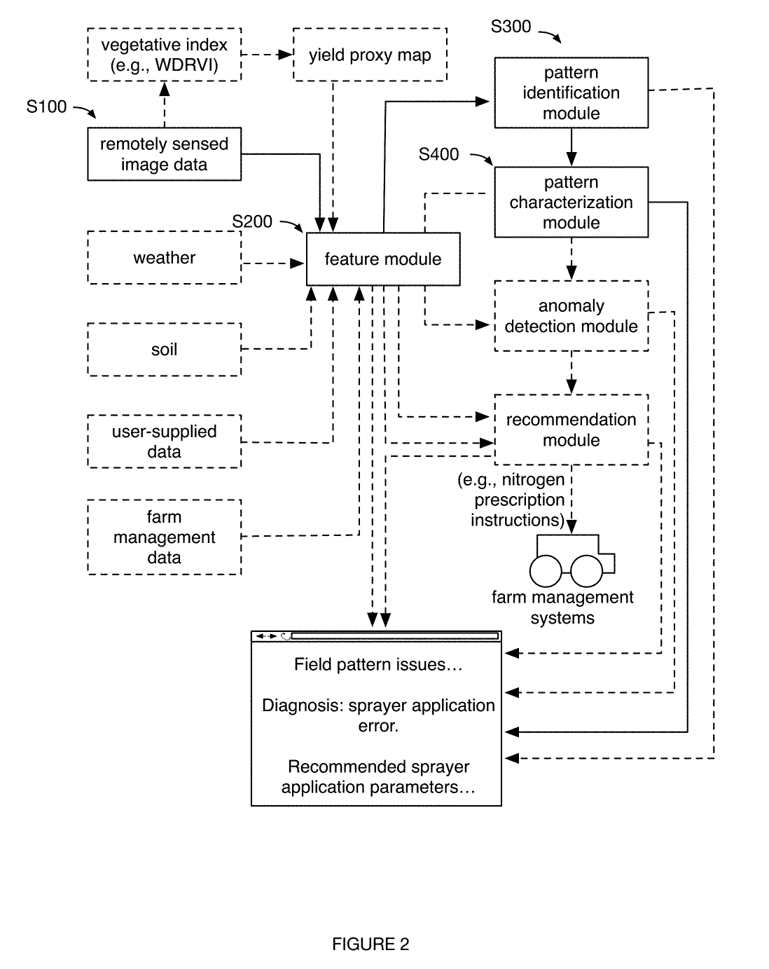

As shown in FIG. 2, embodiments of a system for characterizing field patterns can include: a feature module, a pattern identification module, and a pattern characterization module. Additionally or alternatively, embodiments of the system can include: an anomaly detection module, a recommendation module, farm management systems (e.g., for the geographic region, including calendaring systems, farming activity logging systems, etc.), databases (e.g., databases including remotely sensed data, weather databases, soil databases, etc.), social networking systems, and/or any other suitable components. The system and/or components of the system (e.g., modules, databases, farm management systems, etc.) can entirely or partially be executed by, hosted on, communicate with (e.g., wirelessly, through wired communication, etc.), and/or otherwise include: a remote computing system (e.g., servers, at least one networked computing system, stateless, stateful, etc.), a local computing system, vehicles, user devices, and/or by any suitable component. While the components of the system are generally described as distinct components, they can be physically and/or logically integrated in any manner. However, the functionality of the system can be distributed in any suitable manner amongst any suitable system components.

Modules and/or other components of the system can include: probabilistic properties, heuristic properties, deterministic properties, and/or any other suitable properties. The modules can applying any suitable processing operation (e.g., for image processing, feature extraction, etc.) including: image processing techniques (e.g., image filtering, image transformations, histograms, structural analysis, shape analysis, object tracking, motion analysis, feature detection, object detection, stitching, thresholding, image adjustments, etc.), clustering, performing pattern recognition on data, fusing data from multiple sources, combination of values (e.g., averaging values, processing pixel values, etc.), compression, conversion, normalization, updating, ranking, validating, filtering (e.g., for baseline correction, data cropping, etc.), noise reduction, smoothing, filling (e.g., gap filling), aligning, model fitting, windowing, clipping, transformations, mathematical operations (e.g., derivatives, moving averages, summing, subtracting, multiplying, dividing, etc.), interpolating, extrapolating, visualizing, and/or any other suitable processing operations.

Modules and/or other components of the system can include and/or otherwise apply models associated with one or more of: classification, decision-trees, regression, neural networks (e.g., convolutional neural networks), heuristics, equations (e.g., weighted equations, etc.), selection (e.g., from a library), instance-based methods (e.g., nearest neighbor), regularization methods (e.g., ridge regression), Bayesian methods, kernel methods, supervised learning, semi-supervised learning, unsupervised learning, reinforcement learning, and/or any other approach. The module(s) can be run or updated: once; at a predetermined frequency; every time an instance of an embodiment of the method and/or subprocess is performed; every time an unanticipated measurement value is received; and/or at any other suitable frequency. Any number of instances of any suitable types of modules can be run or updated concurrently with one or more other modules, serially, at varying frequencies, and/or at any other suitable time.

The inputs and/or features (e.g., parameters used in an equation, features used in a machine learning model, etc.) used in modules can be determined through a sensitivity analysis, used for a plurality of modules (e.g., using image features generated from the feature model as inputs for both the pattern identification module and the pattern characterization module, etc.), received from other modules (e.g., outputs), received from a user account (e.g., from the farmer, from equipment associated with the user account, etc.), automatically retrieved (e.g., from an online database, received through a subscription to a data source, etc.), extracted from sampled sensor signals (e.g., remotely sensed images, sensor data from farm management systems, etc.), determined from a series of sensor signals (e.g., signal changes over time, signal patterns, etc.), and/or otherwise determined. Additionally or alternatively, inputs for the modules can include and/or otherwise be derived from types of data described in and/or analogous to U.S. application Ser. No. 15/012,749 filed 1 Feb. 2016; U.S. application Ser. No. 15/645,535 filed 10 Jul. 2017; and U.S. application Ser. No. 15/202,332 filed 5 Jul. 2016, each of which are herein incorporated in their entireties by this reference. However, inputs, features, outputs, and/or other data associated with the modules can be configured in any suitable manner. The modules (and/or portions of the method) are preferably universally applicable (e.g., the same models used across all user accounts, fields, and/or analysis zones), but can alternatively be specific to a user account, geographic region (e.g., field, sub-region, etc.), field pattern, crop (e.g., corn, soy, alfalfa, wheat, rice, sugarcane, etc.), and/or can otherwise differ.

The feature module can function to determine features for identifying and/or characterizing field patterns. Inputs used in generating, executing, and or updating the feature module (and/or any other suitable module) can include any one or more of: remotely sensed imagery data, farm management data (e.g., schedule of farm management activities; data associated with completed farm management activities; farm management system sensor data; etc.), weather data, soil data, topological data, altitude data, data extracted from physical soil samples, data collected from third party databases, user-inputted data, and/or any other suitable inputs. Image data preferably includes satellite imagery of a target geographic region (e.g., a crop field, etc.), geographically proximal regions, and/or any suitable geographic regions. Additionally or alternatively, remotely sensed imagery data can include aerial imagery (e.g., drone images, NAIP), LIDAR, satellite radar, or any other suitable remote data. Each image can be recorded in one or more spectra. However, image data can be otherwise.

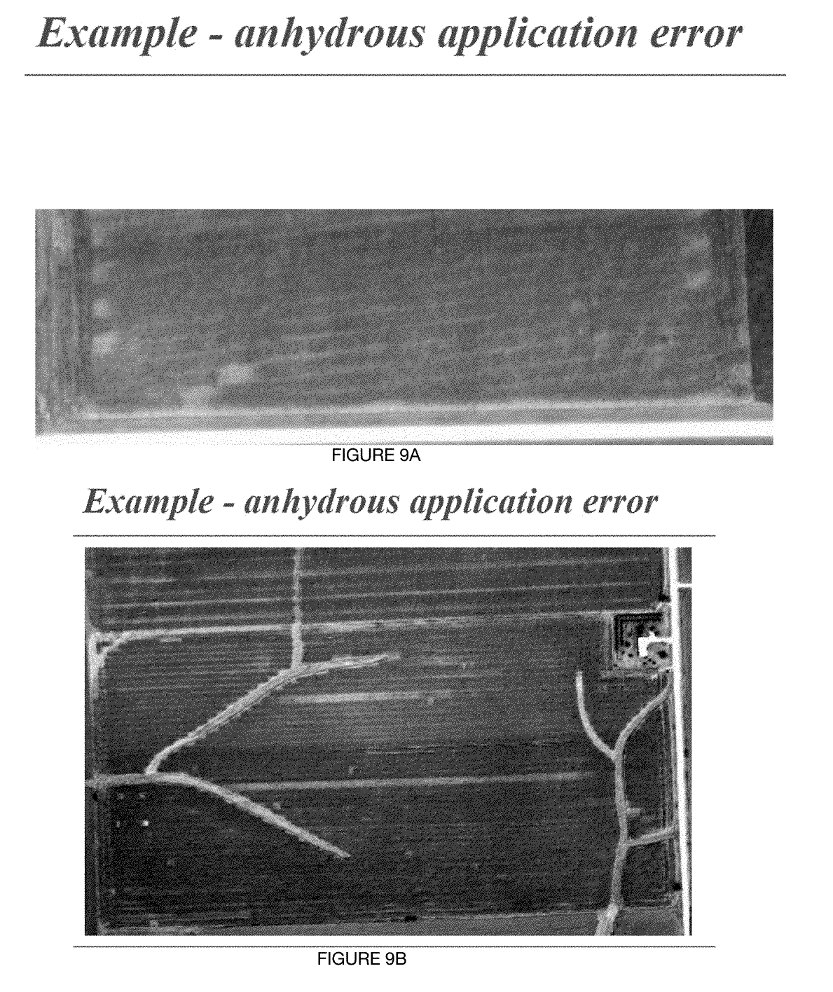

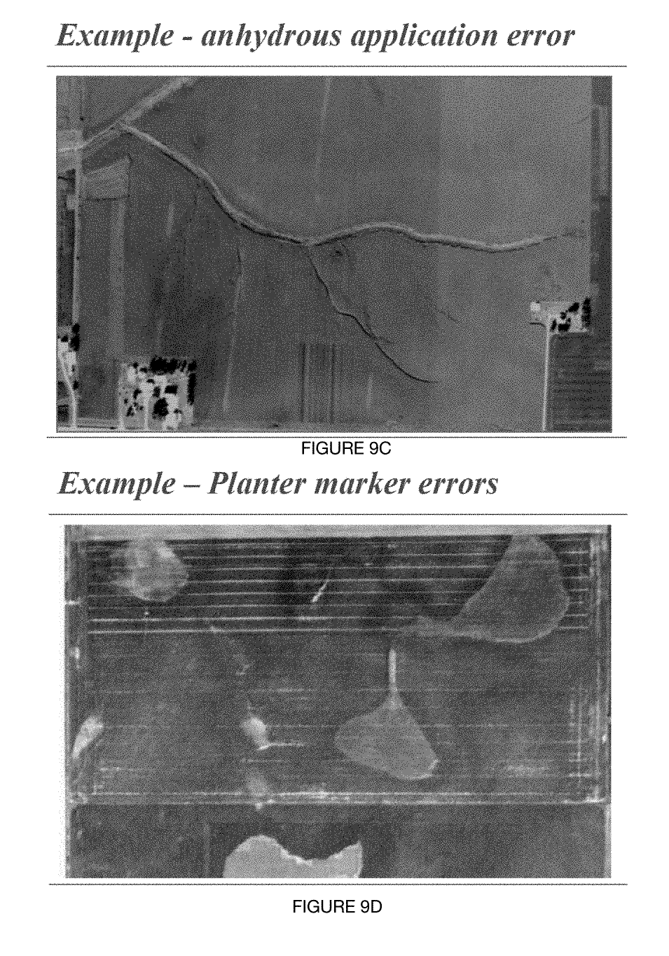

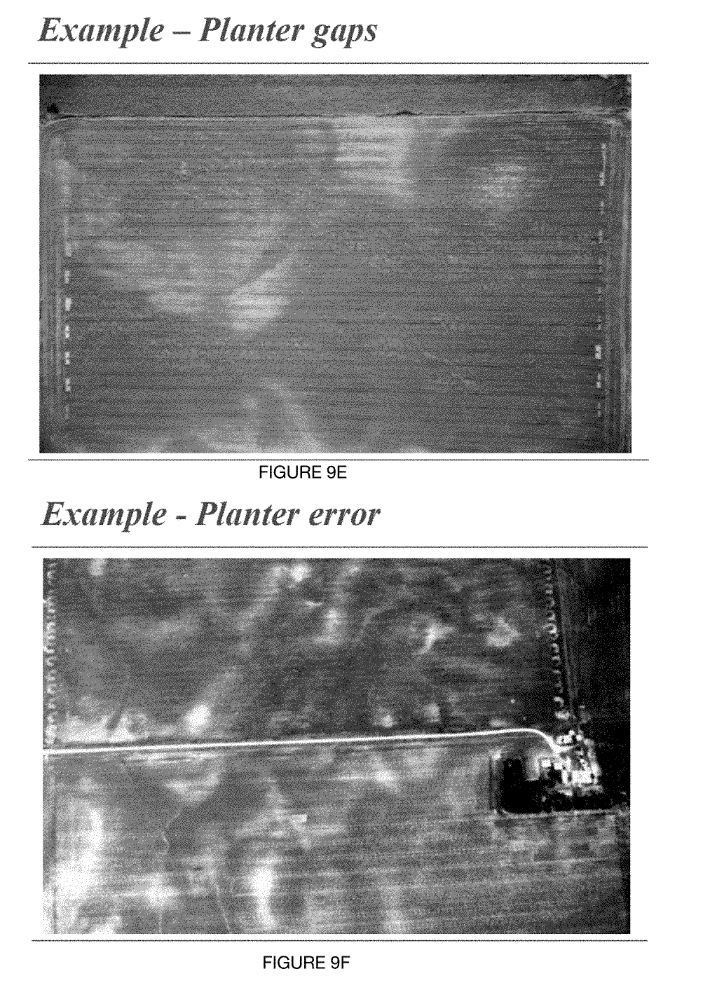

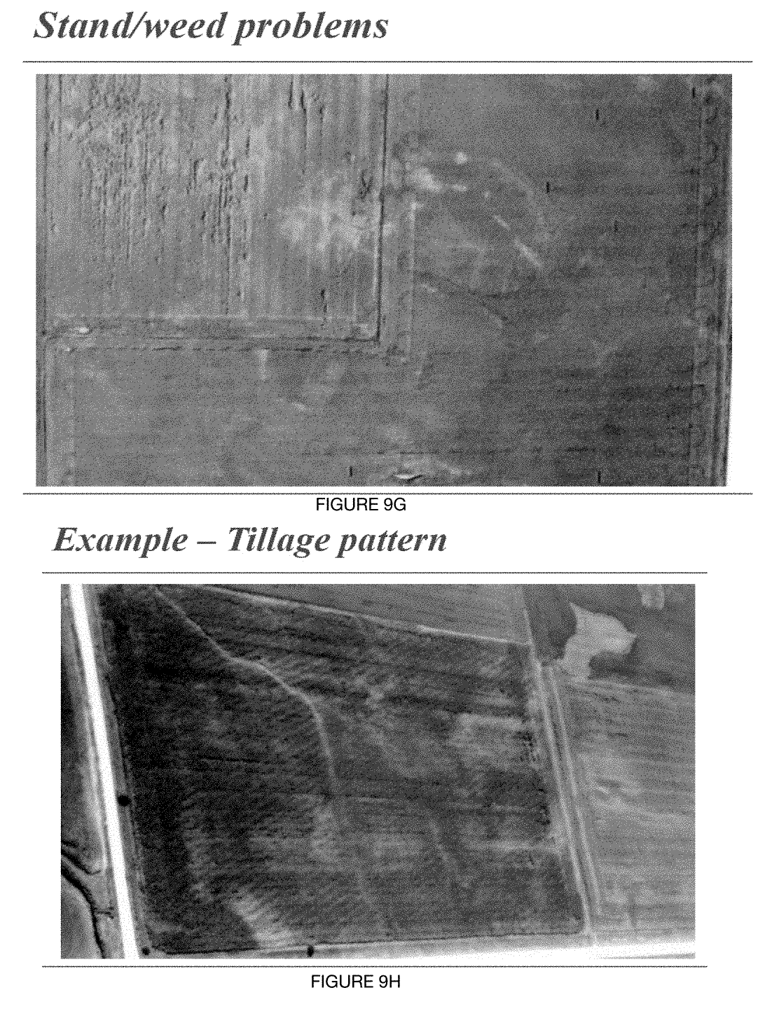

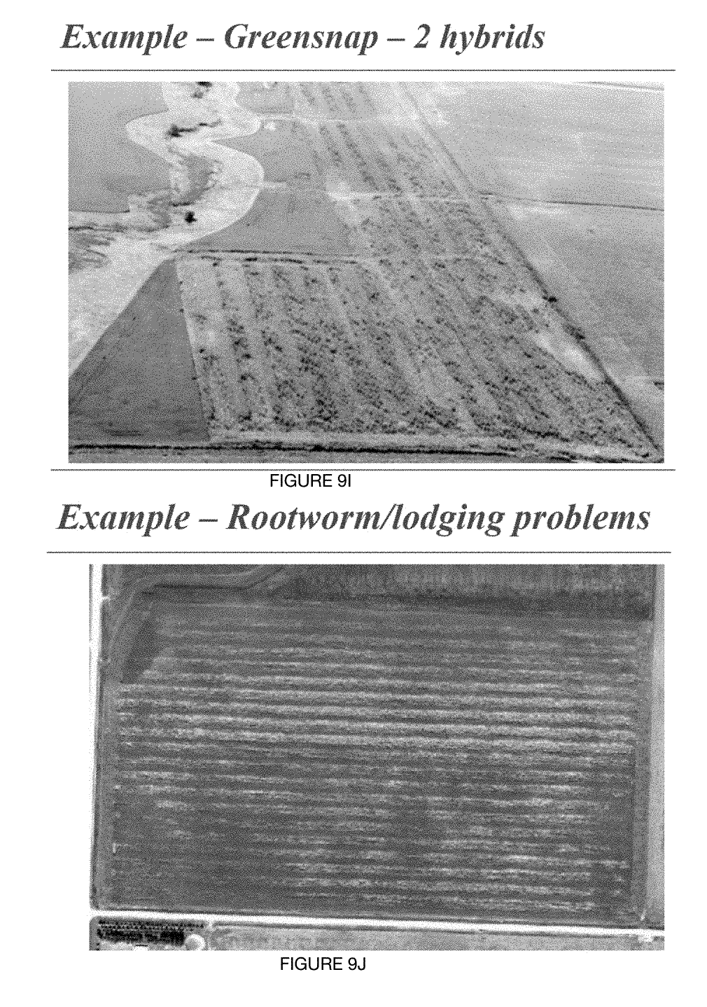

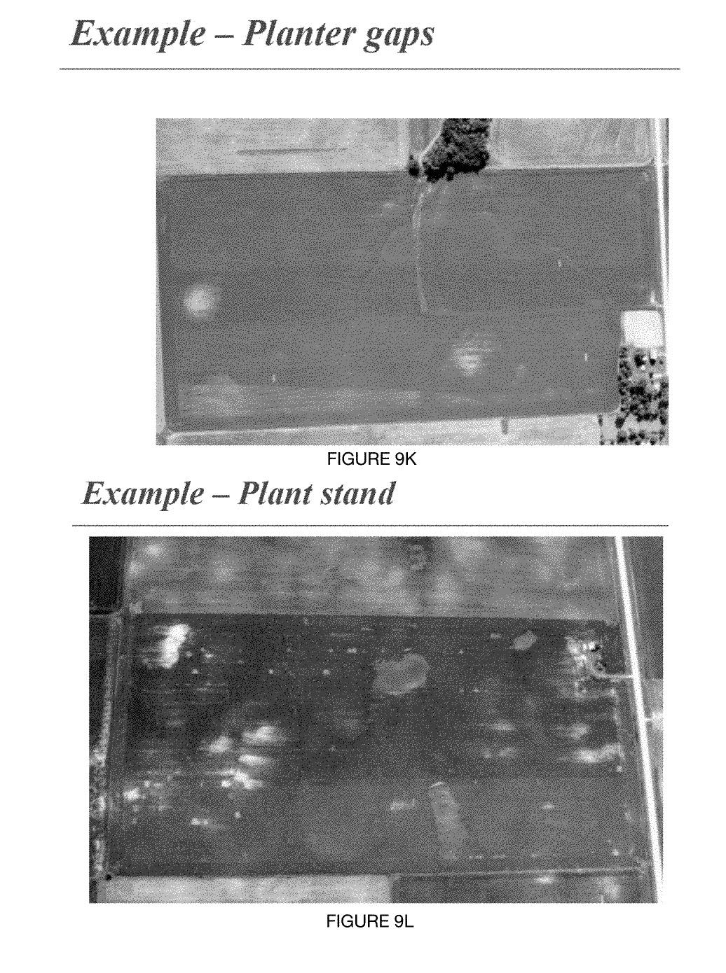

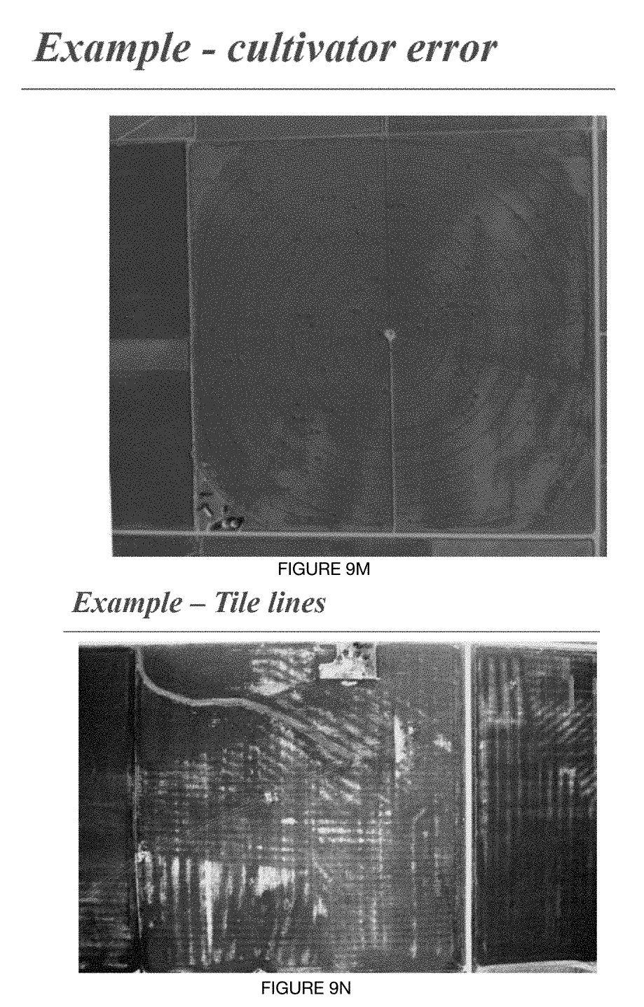

The feature module can output any one or more of: image features, farm management features (e.g., features associated with tillage operations, spraying operations, seeding operations, harvesting operations, such as times of operation, locations of operation, operation type such as primary tillage versus secondary tillage, equipment sensor data, types of equipment, materials used, crop type, etc.), seeding features (e.g., based on the seed rate, seed prescription, seeding equipment capabilities, etc.), growth stage features (e.g., prior crop growth stage; current crop growth stage; historic growth stage at a recurrent time point for a growing season; growing degree day values and/or other indexes; as received from a user; automatically estimated; etc.), crop density coefficients (e.g., for specific hybrids), crop stressor features (e.g., weather parameters, soil parameters, topological parameters, historic vegetative performance values such as historic LAI, treatment history such as watering history and/or pesticide application history, disease history, pest history, crop anomaly history, etc.), yield features (e.g., current yield; historic yield; yield determined based on image data and/or non-image data; etc.), proxy map features (e.g., yield proxy map), altitude features, topological features, features associated with the specific patterns described in FIGS. 9A-9N, historic features associated with historic identification and/or characterization of field patterns, and/or any other suitable features associated with field patterns.

Image features can include: pre-processing features (e.g., features extracted from images processed with operations associated with greyscale, saturation, blurring, thresholding, transformations such as wavelet transformations, etc.), shape features (e.g., results of line segment detection, polygon detection, circle detection, and/or other shape detection; line segment length and/or other dimensions; angle of line segments, such as median angle for the line segments relative to a suitable reference point; distance between line segments; number of line segments; density of line segments in an area; line segment cluster features based on clustering on line segment characteristics; and/or other suitable line segment characteristics; shape detection features based on shape detection processes; etc.), spectral and/or multi-spectral features (e.g., band values such as for blue, green, red, red edge, near infra-red; detecting crop type based on color features, such as detecting corn based on yellow color features; band combination and calculations; etc.), orientation features (e.g., solar angle, satellite angle, etc.), object detection features (e.g., object classifications; quantity of detected objects; object types; etc.), metadata features (e.g., date, time, image capture system characteristics, etc.), and/or any other suitable image features.

A feature module preferably includes a plurality of feature submodules employing different algorithms and/or other techniques in generating different types of outputs (e.g., different computer vision algorithms for generating different types of image features; different algorithms for generating image features versus non-image features; etc.), but feature modules can employ any suitable distribution of algorithms and/or approaches. In a variation, the feature models can process image data inputs to generate a feature set including only image features (e.g., where identification and/or characterization of field patterns can be based exclusively on image features; etc.). In an example, line segment features extracted from image data can be generated (e.g., for a geographic region including linear, consistent field patterns, such as in a pattern of parallel, straight lines, etc.). In a specific example, the feature module can be configured to detect line segments; filter line segments based on a threshold length (and/or other suitable line segment characteristic, such as angle); and determine a cycle (e.g., distance between line segments), amount of the geographic region covered by the line segments (e.g., percent of field covered by the line segments, such as assuming a line segment width, etc.), and line segment orientation (e.g., median angle relative a reference point; etc.) for the filtered line segments, where such features can be used in identifying and/or characterizing field patterns. In another example, image features associated with non-linear patterns (e.g., parallel, non-linear patterns; circular patterns; etc.) can be extracted, but features can be extracted for any suitable pattern shape and/or configuration. In another example, orientation of line segments and/or other suitable shapes can be determined relative to references including any one or more of: true north, crop row orientation (e.g., which can be compared to equipment pattern orientations, such as created from farm management system traversal paths; etc.), geographic region orientation (e.g., relative other geographic regions, relative other suitable visual indicators, etc.), other patterns, and/or any other suitable references. In another example, the feature module can process remotely sensed imagery data for any suitable number of geographic regions (e.g., adjacent geographic regions; geographically separate regions; etc.), crop types (e.g., for different crop types across different geographic regions associated with a user), time periods (e.g., extracting current image features from current images of a geographic region, and historic image features from historic images of a geographic region; etc.), users (e.g., processing imagery data across geographic regions for different users; where image features for geographic regions of a first user can be compared against features for geographic regions of a second user; etc.) and/or other suitable aspects.

In another variation, feature models can process non-image data to generate feature sets including non-image features. For example, farm management data (e.g., farm management system operation data such as sensor data, user inputs at the systems, other data collected at the systems; seed production records for the geographic regions; etc.) can be used as features and/or in generating features (e.g., as a training database for training pattern identification models and/or characterization models; etc.). In a specific example, application data (e.g., as-applied sources of data) can be used as inputs into modules of the system (e.g., pattern identification module, pattern characterization module, etc.). Application data can include fertilizer application parameters, which can include any of: fertilizer type (e.g., nitrogen, phosphorous, potassium, etc.); application amount; corresponding location parameters; application time; farm management systems used; associated sensor data; and/or other suitable fertilizer application parameters. Application data can be derived from: farmer inputs (e.g., at a web application, etc.); farm management system data (e.g., associated sensor data; etc.); variable rate application prescriptions (e.g., recommended prescriptions; etc.); and/or other suitable sources. Additionally or alternatively, application data can include, be analogous to, and/or be processed in a manner analogous to that described in U.S. application Ser. No. 15/483,062 filed 10 Apr. 2017. In another variation, feature sets including image features and non-image features can be generated. In another variation, features can include raw data (e.g., raw inputs; data unmodified by the feature module; etc.). Additionally or alternatively, any combination of data of different data types and/or associations with temporal indicators can be used as inputs into modules of the system. In a specific example, late-season imagery, rainfall parameters (e.g., above-average rainfall in areas of low elevation where water aggregates; etc.), and application data (e.g., nitrogen application data associated with the season) can be used in the pattern characterization module and/or anomaly detection module (e.g., for diagnosing crop stresses for corn; etc.). However, inputs and outputs of feature modules can be configured in any suitable manner.

The inputs (and/or outputs) for the feature module (and/or other suitable module) can be associated with the same time period (e.g., remotely sensed data of the geographic region collected for May of a current year; farm management system sensor data collected for the same time period; data collected for the same growing season; such that the data associated with the same time period can be analyzed together and/or otherwise processed based on their temporal associations; etc.), be associated with different time periods, and/or be associated with any other suitable time periods that are related in any suitable manner. For example, a schedule of farm management activities for a user is preferably up-to-date, and soil data can include up-to-date and/or historic soil data (e.g., collected before the growing season began). The inputs are preferably automatically collected (e.g., from a third party service for the remotely sensed data; from a third-party database such as the Soil Survey Geography database; received from communications by farm management systems; from user accounts associated with users; etc.), but can additionally or alternatively be manually collected (e.g., manually transmitting API requests to third party databases; manually requesting farm management data from users at an interface; etc.) and/or otherwise collected. However, the feature module can be configured in any suitable manner.

The pattern identification module can function to identify (e.g., detect, classify, etc.) one or more field patterns for a geographic region. Field patterns can include: manmade patterns (e.g., equipment-induced field patterns; field patterns associated with tillage operations, spraying operations, seeding operations, harvesting operations, other farm management activities and/or systems; patterns generated from controllable activities; etc.), natural patterns (e.g., weather-based patterns; soil variation-based patterns; topological-based patterns; landscape-based parameters; etc.), patterns associated with any suitable time periods (e.g., patterns persisting over a plurality of growing seasons; a pattern generated during a current growing season, as indicated by a comparison between current and historic image data; etc.), and/or any other suitable types of patterns.

Inputs used in generating, executing, and or updating the pattern identification module (and/or any other suitable module) preferably include features associated with one or more feature modules (e.g., generated features, raw inputs, etc.), but can additionally or alternatively include any suitable types of data. In an example, the pattern identification module can be trained using a manually collected training set (e.g., including image features and/or other suitable features for geographic regions associated with known yields, such as manually supplied by users; etc.).

The pattern identification module can output any one or more of: classifications of a geographic region as including or excluding field patterns; classifications of types of field patterns (e.g., classifications as manmade patterns, as natural patterns, etc.); determinations of number of field patterns; locations (e.g., coordinates); identification of a plurality of field patterns in a geographic region (e.g., identifying both manmade and natural patterns in a geographic region; etc.); and/or any suitable identifiers of field patterns.

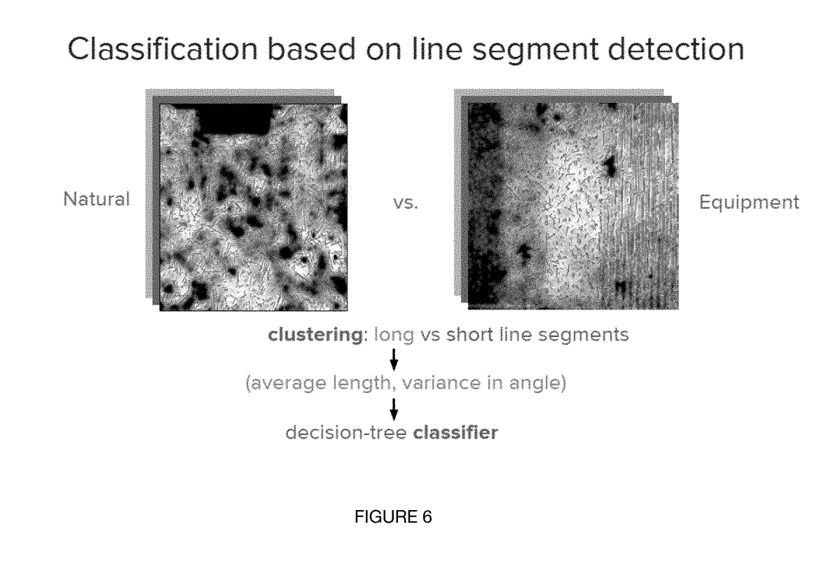

In a variation, the pattern identification module can use current image features. For example, as shown in FIG. 6, the pattern identification module can detect the presence of manmade field patterns based on line segment features (e.g., extracted from current, remotely sensed image data for the geographic region, etc.) of average length and variance in angle for line segments exceeding a threshold length (e.g., through clustering based on line segment length, etc.). In a second example, the pattern identification module can: identify line segments within the current image, cluster adjacent line segments together into longer line segments, determine features of the resultant longer line segments (e.g., average length, diagonal length, relationship to neighboring line segments, such as parallel line segments, etc.), and classify the identified pattern (e.g., line segments) as an equipment pattern (e.g., pattern resulting from equipment treatment of the field) based on the features (e.g., using a decision tree classifier). Adjacent line segments can be: line segments separated by less than a predetermined distance or pixel count, line segments substantially aligned with each other (e.g., within ±5%, 10%, 20%, 30%, between 0% and 50%, or other percentile deviation from a straight line or estimated equipment path), or otherwise determined. The adjacent line segments can optionally be de-noised (e.g., using a filter) prior to clustering. Features of the resultant longer line segments can include: segment length, average length of the longer line segments, diagonal length, width, variance in angle, parallelism to neighboring line segments, distance between cycles, orientation (e.g., relative to cardinal coordinates, relative to a field reference point, etc.), proportion of the field, or any other suitable set of features. In a specific example, the pattern can be classified as an equipment pattern when the average length of the longer line segments is greater than a predetermined percentage (e.g., 10%, 20%, etc.) of a longer line's diagonal dimension and/or the set of longer line segments' diagonal dimension. However, the pattern can be otherwise classified as an equipment pattern.

In another variation, the pattern identification module can compare current image features for the geographic region (e.g., associated with a recurrent time period) to historic image features for the geographic region (e.g., associated with a different occurrence of the recurrent time period). For example, such comparisons can be used to classify current field patterns based on expected field patterns (e.g., for the recurrent time period; based on historic prevalence of field patterns associated with the geographic region; etc.); however, any suitable current and/or historic features (e.g., non-image features) can be compared and/or otherwise used by the pattern identification module.

In another variation, the pattern identification module can compare features for the target geographic region to reference features for other geographic regions (e.g., geographically proximal regions, such as adjacent regions; geographic regions associated with the user managing the target geographic region; geographic regions with similar characteristics to the target geographic region, such as similar weather parameters, crop type, farm management activities, and/or other similarities; other suitable geographic regions that can act as a basis for comparison; etc.). In a specific example, image features (e.g., line segment features) for a target geographic region can be compared to supplemental image features for geographically proximal regions (e.g., where the supplemental image features are known to be associated with a particular type of field pattern; and classifying the target geographic region as including the particular type of field pattern in response to the image features being similar to the supplemental image features beyond a threshold; etc.). In another specific example, features for a target geographic region can be compared to reference features (e.g., generated based on features extracted across a plurality of geographic regions; reference feature sets; etc.) associated with different field pattern profiles (e.g., typifying different field pattern types; field pattern characteristics; etc.). However, features associated with any suitable geographic regions can be compared and/or otherwise processed.

In another variation, the pattern identification module can leverage non-image features. For example, farm management data detailing traversal paths of farm management systems can be analyzed against yield data to identify field patterns correlated with the yield data. In another example, farm management data indicating the use of particular farm management equipment for a plurality of geographic regions (e.g., associated with the same user, associated with different users) can be used in comparing image features between the plurality of geographic regions (e.g., where the particular farm management equipment can result in field patterns of particular types and/or other characteristics; where field pattern identification for a first geographic region of the plurality can be based on image feature similarity between the first geographic region and a second geographic region of the plurality, where the second geographic region is associated with known field patterns; etc.).

Any number of pattern identification modules employing same or different approaches (e.g., algorithms; compared to other pattern identification modules; compared to other types of modules; etc.) can be used. In an example, image features (e.g., line segment features) can be used in a decision-tree classifier to classify manmade patterns versus natural patterns. In another example, the pattern identification module can apply a neural network model (e.g., a convolutional neural network model), with inputs of image data (e.g., pixel values; current image data; historic image data; image data for other geographic regions; etc.), non-image features (e.g., weather parameters, soil parameters; altitude features; topography features; etc.), and/or other suitable features into the neural input layer of the neural network model. However, pattern identification modules can be configured in any suitable manner.

The pattern characterization module can function to characterize (e.g., evaluate, assess, determine pattern characteristics for, process, etc.) field patterns identified for a geographic region, where the pattern characteristics can be presented to a user, used as inputs into other modules (e.g., anomaly detection module, recommendation module, etc.), and/or otherwise purposed. Inputs used in generating, executing, and or updating the pattern characterization module (and/or any other suitable module) preferably include remotely sensed data (e.g., image data) identified by the pattern identification module as including field patterns (e.g., as including manmade field patterns, etc.). In examples, image inputs for the pattern characterization module can include raw images (e.g., of a geographic region including the identified field patterns; etc.), processed images (e.g., processed by the feature module during feature extraction prior to pattern identification; etc.), and/or other suitable image data. Additionally or alternatively, the pattern characterization module can process inputs including features (e.g., image features, non-image features, etc.) extracted by the feature module, where such features can be used as inputs for the pattern identification module, the pattern characterization module, and/or other suitable modules. However, any suitable inputs can be leveraged by the pattern characterization module.

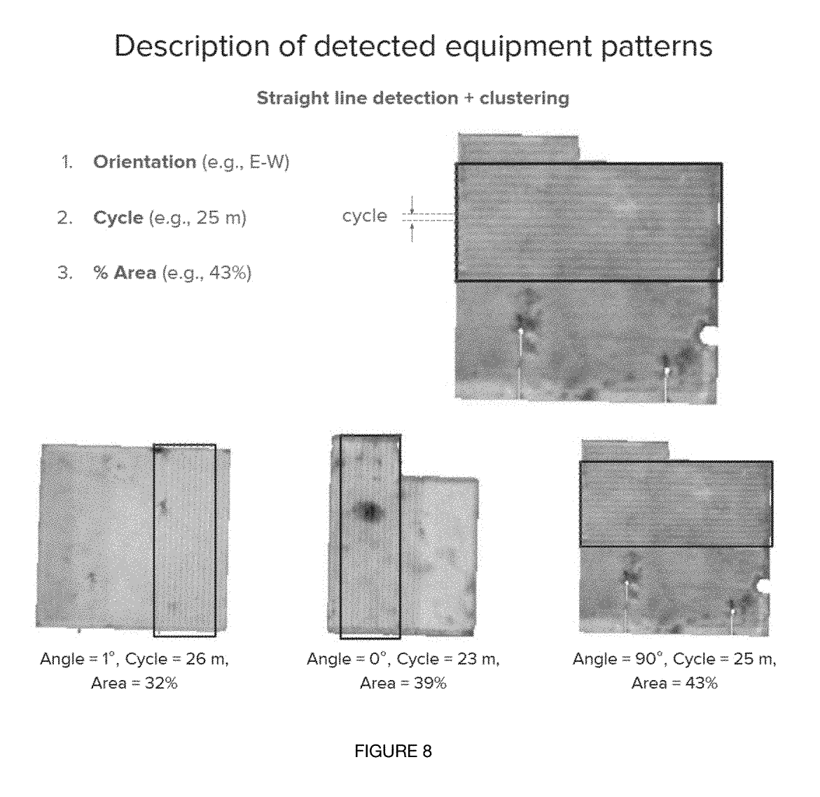

The pattern characterization module preferably outputs pattern characteristics, which can include one or more of: shape characteristics (e.g., as shown in FIG. 8; shape orientation such as line segment orientation; shape cycle such as distance between adjacent patterns; shape area such as a percent of the geographic region covered by the field patterns; shape characteristics similar to or the same as the shape features described in relation to the feature module; etc.), features determined by the feature module, and/or any other suitable pattern characteristics.

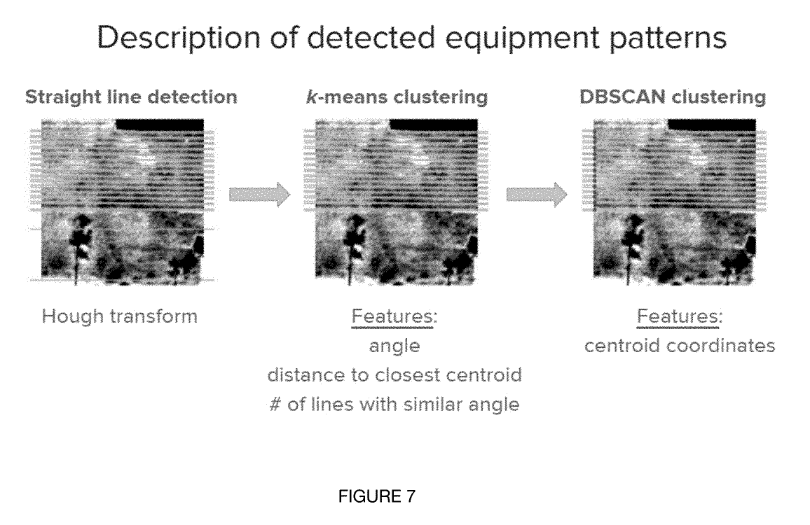

Any number of pattern characterization modules employing same or different approaches (e.g., compared to other pattern characterization modules; compared to other types of modules such as a feature module; etc.) can be used. In an example, as shown in FIG. 7, the pattern characterization module (and/or other suitable modules) can be configured to receive images of geographic regions including identified field patterns as inputs; perform straight line detection on the images (e.g., through Hough transform, Principal Component Analysis, Laplacian line detection, parametric feature detection, pixel value thresholding, Maximum Likelihood Estimator, convolution of line detection masks, etc.); perform a first clustering (e.g., k-means clustering, etc.) based on the detected straight lines (e.g., based on a feature set for the detected straight lines, where the feature set can include line orientation such as angle, distance to closest centroid, number of lines with similar orientation, features associated with the feature module, etc.); performing a second clustering (e.g., DBSCAN clustering) based on the centroid coordinates, where such processes can be used in determining pattern characterizations. Additionally or alternatively, the pattern characterization module can use any algorithms and/or other approaches described herein, and/or can be configured in any suitable manner.

Embodiments of the system can additionally or alternatively include an anomaly detection module, which can function to detect field anomalies associated with identified field patterns of a geographic region. Field anomalies can include any one or more of: field pattern-related causes of farm management metrics (e.g., yield deficiencies; greater than expected yield; nutrient statuses; causes of field patterns; type of farm management activity leading to a field pattern; type of natural parameter leading to a field pattern; etc.); farm management errors; and/or other suitable insights (e.g., diagnoses) associated with field patterns. Additionally or alternatively, anomaly detection modules can output any suitable data. Inputs used in generating, executing, and or updating the anomaly detection module (and/or any other suitable module) preferably include features and/or other data extracted by at least one of the feature module, pattern identification module, and the pattern characterization module, but can include any suitable inputs (e.g., historic outputs of the anomaly detection module and/or recommendation module, etc.). However, anomaly detection modules can be configured in any suitable manner.

Embodiments of the system can additionally or alternatively include a recommendation module, which can function to generate recommendations for one or more users based on the field patterns. Recommendations can include one or more of: precision crop applications (e.g., variable application of pre-emergent herbicide, soil insecticide, residual type herbicides, fertilizers, etc.); precision crop treatment (e.g., by a farming machine); precision crop planting; prescriptions (e.g., fertilizer prescriptions; spraying prescriptions; seeding prescriptions; etc.); other farm management recommendations; data collection recommendations (e.g., for automating data collection from farm management equipment, for use as inputs into modules, etc.); and/or any other suitable recommendations. Inputs used in generating, executing, and or updating the recommendation module (and/or any other suitable module) preferably include features and/or other data used by and/or generated by other modules of the system, but can additionally or alternatively include historic outputs of the recommendation module (e.g., for iteratively refining recommendations for users, etc.), and/or other suitable inputs. Recommendations and/or associated benefits can be for any suitable temporal indicators and/or combination of temporal indicators. In examples, recommendations can be for a current season (e.g., a recommendation to be implemented in the current season for the benefits to accrue in a future season; a recommendation and associated benefits for a current season; etc.), between seasons, a future season (e.g., a recommendation to be implemented in a future season, etc.), and/or for any other suitable time period. In a specific example, a recommendation for a detected anomaly (e.g., based on characterized field patterns) can be for an upcoming season (e.g., as opposed to the current season, when the anomaly is not yet correctable; etc.). However, the recommendation module can be configured in any suitable manner.

### 4. Method

Receiving remotely sensed data of a geographic region S100 can function to obtain image data and/or other suitable remotely sensed data (e.g., farm management system data; etc.) for subsequent downstream processing (e.g., by modules of the system). Receiving remotely sensed data preferably includes receiving and storing the data at a remote computing system (e.g., in association with geographic region identifiers, user accounts, inputs and/or outputs of modules, and/or other suitable data), but can be received and/or otherwise processed by any suitable entities. However, receiving remotely sensed data can be performed in any suitable manner.

The method can additionally or alternatively include filtering the remotely sensed data, which can function to select a subset of the remotely sensed data to process downstream (e.g., where such filtering can improve processing efficiency for scaling the embodiments of the method and/or system to be able to analyze increasing amounts of geographic regions, associated data, etc.). Filtering can be based on one or more of: farm management metrics (e.g., selecting geographic region associated with low productivity, such as relative an expected level of yield based on historic yields; selecting geographic regions associated with optimal yield to be able to analyze field patterns correlated with such yield; etc.); features associated with the feature module; type of geographic region; type of user; requests for field pattern analysis; and/or any other suitable criteria. However, filtering remotely sensed data and/or other suitable data can be performed in any suitable manner.

Determining a feature set for the geographic region based on the remotely sensed data S200 can function to generate features (e.g., using a feature module) for subsequent field pattern identification and/or characterization. Any suitable types of features can be determined in any suitable temporal sequence (e.g., serially, concurrently, etc.) relative other features. In an example, the method can include: receiving remotely sensed image data at a remote computing system; extracting an initial image feature set for the remotely sensed image data; selecting a subset of the remotely sensed image data based on the initial image feature set; extracting a final feature set for the subset of image data; and identifying and/or characterizing field patterns (and/or performing other portions of the method) based on the final feature set. However, determining features can be performed at any suitable time and frequency, and can be performed in any suitable manner.

Identifying field patterns based on the feature set S300 can function to detect one or more field patterns for a geographic region (e.g., using a pattern identification module). In a variation, identifying field patterns (and/or other suitable portions of the method) can include applying an ensemble approach. For example, identifying, characterizing, diagnosing, and/or providing recommendations in relation to field patterns can include using inputs that include different outputs from different modules (e.g., feature modules, yield estimation modules, weather modules, soil module) used serially (e.g., outputs from a first module used in a second module, etc.), concurrently (e.g., feature vectors including the different inputs), and/or in any suitable manner. In another variation, identifying field patterns can include using different pattern identification modules (e.g., generated with different algorithms, with different sets of features, with different input and/or output types, etc.) for different purposes, such as one or more of: different geographic regions, users, feature sets, crop types, time periods (e.g., different time periods in a growing season, etc.), historic data, and/or other suitable criteria. Additionally or alternatively, different modules can be used for different purposes in relation to any suitable portions of the method. However, identifying field patterns can be performed in any suitable manner.

Determining pattern characteristics S400 functions to determine one or more aspects regarding the identified field patterns. Determining pattern characteristics is preferably based on images for geographic regions identified as including target field patterns. In an example, determining pattern characteristics can include: retrieving a set of images for a geographic region identified as including target field patterns; and generating pattern characteristics over time for the field patterns of the geographic region (e.g., changes in pattern characteristics of field patterns; presence of new field patterns; absence of historically observed field patterns; predictions of future field patterns; etc.). Determining pattern characteristics is preferably in response to identifying field patterns, but can be performed at any suitable time and frequency, and can be performed in any suitable manner.

The method can additionally or alternatively include identifying a field anomaly based on the field patterns, which can function to detect one or more anomalies associated with the field patterns. In variations, identifying field anomalies can be based on: historic image data (e.g., differences between historically observed field patterns and currently observed field patterns for the same geographic region, for different geographic regions; etc.); reference features (e.g., comparing current image features to a reference image features associated with field anomalies; comparing field patterns for a target geographic region to related geographic regions, such as regions managed by the same user, regions with similar features, and/or other regions; filtering the reference features used for comparison based on the type of field patterns identified and/or characterized for the current geographic region; etc.); farm management activities (e.g., diagnosing an equipment issue based on identifying the same field pattern-related issues across crop types and geographic regions managed by the same user performing the same equipment operations; etc.); and/or other suitable data. In specific examples, identifying field anomalies can include detecting anomalies associated with situations shown in and/or analogous to FIGS. 9A-9N, such as including one or more of: application activities (e.g., anhydrous application errors, such as applications applied at angles to crop rows and/or other reference points; etc.), equipment patterns (e.g., non-parallel equipment patterns; equipment patterns influenced by field contour, elevation of geographic regions, and/or other suitable variables; etc.), planter gaps (e.g., where diagnosis can include distinguishing sprayer patterns versus planter patterns; etc.), tillage patterns (e.g., tillage operations at an angle to crop rows; etc.), weed problems (e.g., where weeds fill in geographic subregions without planting; etc.), multi-hybrid situations (e.g., differentiating between patterns influenced by different crop types; etc.), lodging issues (e.g., due to insufficient application of insecticide; etc.), cultivator error (e.g., patterns generated by cultivator operation; etc.), supplemental objects (e.g., tile lines; power lines; associated patterns; etc.), and/or any other suitable situations. However, identifying field anomalies can be performed in any suitable manner.

The method can additionally or alternatively include: determining a field recommendation based on the field patterns, which can function to provide recommendations (e.g., using the recommendation module) for improving farm management. Recommendations are preferably provided to users (e.g., at a web interface), but can additionally or alternatively be provided to farm management systems (e.g., in the form of control instructions, prescriptions, etc.) and/or other suitable entities. However, providing recommendations can be performed in any suitable manner.

Although omitted for conciseness, the embodiments include every combination and permutation of the various system components and the various method processes, including any variations, examples, and specific examples, where the method processes can be performed in any suitable order, sequentially or concurrently using any suitable system components. The system and method and embodiments thereof can be embodied and/or implemented at least in part as a machine configured to receive a computer-readable medium storing computer-readable instructions. The instructions are preferably executed by computer-executable components preferably integrated with the system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions. As a person skilled in the art will recognize from the previous detailed description and from the figures and claims, modifications and changes can be made to the embodiments without departing from the scope defined in the following claims.

We claim:

1. A method for field analysis, comprising:
receiving an image of an agricultural field;
identifying a field pattern within the image;
determining features of the field pattern;
characterizing the field pattern, based on the features, as one of an equipment pattern or a natural pattern; and
in response to characterization of the field pattern as an equipment pattern, determining an equipment failure based on the features, wherein a piece of agricultural equipment is controlled based on the determined equipment failure.
